(19) United States
(12) Patent Application Publication
(10) Pub. No.: US 2025/0229400 A1
(43) Pub. Date: Jul. 17, 2025

(54) TOOL KIT

(71) Applicant: SHENZHEN LEQI NETWORK TECHNOLOGY CO., LTD, SHENZHEN (CN)

(72) Inventors: ZHIQIANG PAN, SHENZHEN (CN); FENG ZHOU, SHENZHEN (CN); YANG ZHOU, SHENZHEN (CN); XINGXING YUAN, SHENZHEN (CN); JIANLEI ZHANG, SHENZHEN (CN)

(21) Appl. No.: 18/676,512

(22) Filed: May 29, 2024

(30) Foreign Application Priority Data
Jan. 13, 2024 (CN) 202410058605.X

(51) Int. Cl. B25F 1/04; B25B 15/00

(52) U.S. Cl. CPC B25F 1/04; B25B 15/008

(57) ABSTRACT

The present disclosure provides a tool kit including: a first holding member, a second holding member, a tool assembly, and an unlocking assembly. The second holding member is disposed in parallel with the first holding member, and a support cylinder member is connected therebetween to form an accommodation space. The tool assembly includes at least one tool member rotatably accommodated in the accommodation space. An end of the tool member is provided with a rotational connection part, and the rotational connection part is rotatably sleeved on the support cylinder member through a sleeve hole defined in the rotational connection part. The inner wall of the sleeve hole is concavely defined with an engagement groove. The unlocking assembly is movably mounted in a mounting hole of the support cylinder member. The unlocking assembly has a locked state and an unlocked state.

### TECHNICAL FIELD

The present disclosure relates to the field of photography equipment, and in particular, to a tool kit.

### BACKGROUND

In the field of photography equipment, in order to meet different photographic needs of users, such as over-shoulder photography, handheld photography, floor stand photography, track photography, aviation photography, and in-vehicle photography, a variety of photography equipment is needed, and a photography tool kit for the photography equipment is also indispensable. To prevent the loss of the tools, it is common to gather multiple tool wrenches together. The photography tool kit in related art includes multiple wrenches, and adjacent wrenches are connected by way of damping, to realize storage and use of the wrenches. However, the wrenches can only be blocked in a single direction, which is inconvenient to use. Moreover, the unlocking operation is cumbersome and laborious.

### SUMMARY

A main objective of the present disclosure is to provide a tool kit, to solve the technical problem in related art that the unlocking operation is cumbersome and laborious during using the tool kit.

To realize the above objective, the present disclosure provides a tool kit, including:
a first holding member;
a second holding member disposed in parallel with the first holding member, a support cylinder member being connected between the first holding member and the second holding member to form an accommodation space;
a tool assembly, the tool assembly including at least one tool member, the tool member being rotatably accommodated in the accommodation space, one end of the tool member being provided with a rotational connection part, the rotational connection part being rotatably sleeved on the support cylinder member through a sleeve hole defined in the rotational connection part, and an inner wall of the sleeve hole being concavely defined with an engagement groove; and
an unlocking assembly movably mounted in a mounting hole of the support cylinder member, the unlocking assembly including an unlocking button, an engagement member, and a reset member, the engagement member being exposed on an outer surface of the support cylinder member and fitted with the engagement groove, the unlocking button being slidably disposed in the mounting hole and at least partially exposed outside the support cylinder member, and the reset member being configured to apply a force on the unlocking button to reset the unlocking button;
wherein, the unlocking assembly has a locked state and an unlocked state; in the unlocked state, the unlocking button releases the engagement member to allow the engagement member to be disengaged from the engagement groove; and in the locked state, the unlocking button resets to press the engagement member to allow the engagement member to be engaged in the engagement groove.

In some embodiments, the engagement member is located on a sliding path of the unlocking button, the unlocking button is configured to press or release the engagement member, one end of the reset member abuts against or is connected to the unlocking button, and the other end of the reset member abuts against or is connected to a side wall of the mounting hole.

In some embodiments, a pressing surface of the unlocking button is defined with an avoidance groove, and the avoidance groove is configured to avoid the engagement member in a sliding process of the unlocking button so as to release the engagement member.

In some embodiments, the unlocking button includes a pushing part, and a pressing part connected with the pushing part. The pushing part is at least partially exposed outside the support cylinder member, a pressing surface of the pressing part is defined with the avoidance groove and a limiting groove communicated with the avoidance groove, the engagement member is capable of sliding into the avoidance groove along a wall of the limiting groove, the wall of the limiting groove is configured for the pressing part to press the engagement member, a connection area between the wall of the limiting groove and a wall of the avoidance groove defines a pressing area that presses the engagement member, the pressing area is vertically arranged, the limiting groove defines a limiting area connected to the pressing area, and the limiting area is configured to prevent the pressing part from sliding away from the mounting hole.

In some embodiments, the wall of the avoidance groove and the wall of the limiting groove are connected by a guidance inclined surface.

In some embodiments, the pressing surface of the pressing part is defined with a plurality of the avoidance grooves which are spaced apart. The number of the avoidance grooves, the number of the limiting grooves, the number of the engagement members, and the number of the tool members are matched with one another.

In some embodiments, an inner wall of the sleeve hole is recessed with at least two engagement grooves which are spaced apart; in case the tool member is accommodated in the accommodation space and in the locked state, the engagement member is engaged in one of the at least two engagement grooves; and in case the tool member is rotated out of the accommodation space and in the locked state, the engagement member is engaged in another one of the at least two engagement grooves.

In some embodiments, a free end of the tool member is provided with any one of a cross wrench, an adjustable hex wrench, an adjustable wrench, a hex wrench, a straight wrench, a bottle opener, and a blade. And/or, the engagement member is a ball. And/or, the support cylinder member is provided with at least one damping gasket.

In some embodiments, the tool assembly is one of two tool assemblies. One tool assembly is located between the first holding member and the second holding member and on a left side, and the other tool assembly is located between the first holding member and the second holding member and on a right side.

In some embodiments, one tool assembly includes three tool members, a damping gasket is abutted between adjacent rotational connection parts, and free ends of the three tool members are respectively provided with a first hex wrench, a second hex wrench, and a third hex wrench; the first hex wrench, the second hex wrench, and the third hex wrench have different sizes and specifications; and the other tool assembly includes four tool members, a damping gasket is abutted between adjacent rotational connection parts, and free ends of the four tool members are respectively provided with a fourth hex wrench, a straight wrench, an adjustable hex wrench, and a cross wrench.

According to the tool kit provided by the present disclosure, in a storage state, all the tool members of the tool assembly are stored in the accommodation space, and the unlocking button partially protrudes from the opening of the mounting hole. When the unlocking assembly is in the locked state and there is a need to use the tool member, a user may push the unlocking button to unlock the tool kit and then rotate the tool member out of the accommodation space. In the above process, the part of the unlocking button exposed outside the support cylinder member is pushed, such that the reset member is compressed, and the unlocking button slides in the mounting hole to release the engagement member. As a result, the engagement member is disengaged from the engagement groove, to allow the tool member to be rotated out of the accommodation space. In the process of rotating the tool member out of the accommodation space, the engagement member is separated from the engagement groove. After the free end of the tool member is rotated to a preset position, the unlocking button is released, such that unlocking button is reset to press the engagement member, to allow the engagement member to be engaged in the engagement groove. In this way, the user can use the tool member with the unlocking assembly locked, which prevents the tool member from sliding relative to the support cylinder member during using the tool member. The unlocking operation is simple and labor-saving, thereby improving the user experience.

### BRIEF DESCRIPTION OF THE DRAWINGS

FIG. 1 is a schematic structural diagram of a tool kit according to an embodiment of the present disclosure.

FIG. 2 is a sectional diagram of a part of the tool kit in FIG. 1 from a perspective.

FIG. 3 is a schematic structural diagram of a tool member of the tool kit according to an embodiment of the present disclosure.

FIG. 4 is a sectional diagram of a part of the tool kit in FIG. 1 from another perspective.

FIG. 5 is a schematic structural diagram of an unlocking button of the tool kit according to an embodiment of the present disclosure.

FIG. 6 is a schematic structural diagram of a support cylinder member of the tool kit according to an embodiment of the present disclosure.

FIG. 7 is a sectional diagram of a part of a tool kit according to another embodiment of the present disclosure.

### REFERENCE NUMERALS

10, first holding member;

20, second holding member;

30, accommodation space;

40, unlocking assembly; 41, unlocking button; 411, pushing part; 412, pressing part; 42, avoidance groove; 43, limiting groove; 431, pressing area; 432, limiting area; 44, engagement member; 45, reset member;

50, support cylinder member; 51, mounting hole; 52, through hole;

60, tool member; 61, rotational connection part; 62, sleeve hole; 621, engagement groove;

70, damping gasket.

### DETAILED DESCRIPTION OF THE EMBODIMENTS

A clear and complete description of the technical solution of the embodiments of the present disclosure will be provided below with reference to the accompanying drawings. Obviously, the described embodiments are only a part of the embodiments of the present disclosure, rather than all of them. Based on the embodiments of the present disclosure, all other embodiments obtained by those skilled in the art without making creative efforts shall fall within the protection scope of the present disclosure.

It should be noted that all directional indications (such as up, down, left, right, front, back) in the embodiments of the present disclosure are merely used to explain relative position relationships or motion conditions between the components in a specific attitude (as shown in the drawings). The directional indication changes as the specific attitude changes.

It should be noted that when an element is described as “being fixed on” or “being arranged on” another element, the element may be directly arranged on the another element or there may be an intermediate element. When an element is described as “being connected to” another element, the element may be directly connected to the another element or there may be an intermediate element.

Moreover, the terms “first”, “second”, and the like in the present disclosure are merely used for description and cannot be understood as indicating or implying their relative importance or as implicitly indicating the number of the technical features indicated. Thus, the feature defined by “first” or “second” may explicitly or implicitly include at least one such feature. In addition, the technical solutions of various embodiments may be combined with each other, but must be based on that the combined technical solutions can be implemented by those skilled in the art. When the combination of the technical solutions is contradictory or impossible to realize, it shall be considered that such combination does not exist and is not within the scope of protection of the present disclosure.

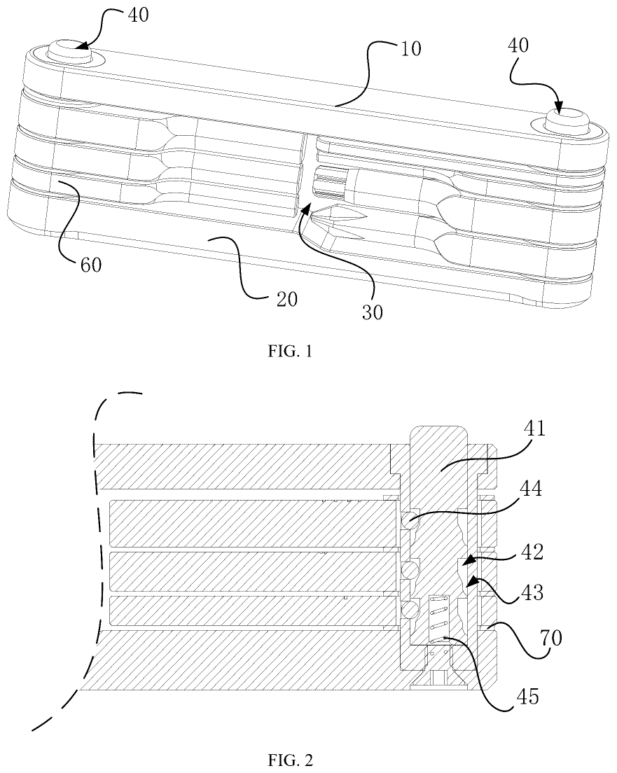

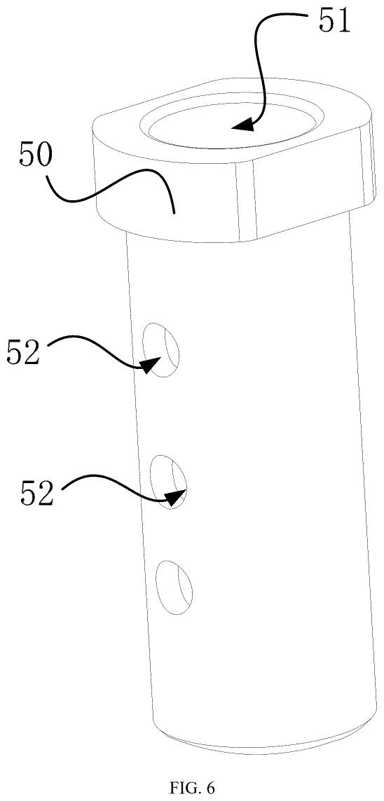

The present disclosure provides a tool kit. Referring to FIG. 1 to FIG. 4, and FIG. 6, the tool kit includes:
a first holding member 10;
a second holding member 20 disposed in parallel with the first holding member 10, a support cylinder member 50 being connected between the first holding member 10 and the second holding member 20 to form an accommodation space 30;
a tool assembly, the tool assembly including at least one tool member 60, the tool member 60 being rotatably accommodated in the accommodation space 30, an end of the tool member 60 being provided with a rotational connection part 61, the rotational connection part 61 being rotatably sleeved on the support cylinder member 50 through a sleeve hole 62 defined in the rotational connection part 61, and an inner wall of the sleeve hole 62 being concavely defined with an engagement groove 621; and
an unlocking assembly 40 movably mounted in a mounting hole 51 of the support cylinder member 50, the unlocking assembly 40 including an unlocking button 41, an engagement member 44, and a reset member 45, the engagement member 44 being exposed on an outer surface of the support cylinder member 50 and fitted with the engagement groove 621, the unlocking button 41 being slidably disposed in the mounting hole 51 and at least partially exposed outside the support cylinder member 50, and the reset member 45 being configured to apply a force on the unlocking button 41 to reset the unlocking button 41.

The unlocking assembly 40 has a locked state and an unlocked state. In the unlocked state, the unlocking button 41 releases the engagement member 44, to allow the engagement member 44 to be disengaged from the engagement groove 621. In the locked state, the unlocking button 41 is reset to press the engagement member 44, to allow the engagement member 44 to be engaged in the engagement groove 621.

In the embodiments, in the storage state, all the tool members 60 of the tool assembly are stored in the accommodation space 30, and the unlocking button 41 partially protrudes from the opening of the mounting hole 51. When the unlocking assembly 40 is in the locked state and a user has a need to use one of the tool members 60, the user may push the unlocking button 41 to unlock the tool kit and then rotate the tool member 60 out of the accommodation space 30. In the above process, the part of the unlocking button 41 exposed outside the support cylinder member 50 is pushed, then the reset member 45 is compressed and the unlocking button 41 slides in the mounting hole 51 to release the engagement member 44. As a result, the engagement member 44 is disengaged from the engagement groove 621, to allow the tool member 60 to be rotated out of the accommodation space 30. In the process of rotating the tool member 60 out of the accommodation space 30, the engagement member 44 is separated from the engagement groove 621. After the free end of the tool member 60 is rotated to a preset position, the unlocking button 41 is released and thus is reset to press the engagement member 44, to allow the engagement member 44 to be engaged in the engagement groove 621. As such, the user can use the tool member 60 when the unlocking assembly 40 is in the locked state, which prevents the tool member 60 from sliding relative to the support cylinder member 50 during use. The unlocking operation is simple and labor-saving, thereby improving the user experience.

The first holding member 10 and the second holding member 20 may be elongated. The surface of the first holding member 10 facing the second holding member 20 and the surface of the second holding member 20 facing the first holding member 10 may be flat. The surface of the first holding member 10 facing away from the second holding member 20 and the surface of the second holding member 20 facing away from the first holding member 10 may be curved, which makes the appearance aesthetically pleasing. One end of the support cylinder member 50 is fixedly connected to the first holding member 10, and the other end of the support cylinder member 50 is fixedly connected to the second holding member 20. For example, the two ends of the support cylinder member 50 are respectively fastened on the first holding member 10 and the second holding member 20 by two screws; or, one end of the support cylinder member 50 is fastened on the second holding member 20 by a screw, and the other end of the support cylinder member 50 is in an interference-fit connection with the first holding member 10. The support cylinder member 50 plays a connection role and is configured to accommodate the unlocking button 41. There may be one, two, three, four, five, or more than five tool members 60, and adjacent tool members 60 are in a damping connection with each other by a damping gasket 70. The support cylinder member 50, the first holding member 10, the second holding member 20, the tool member 60, the unlocking button 41, the engagement member 44, and the reset member 45 of the tool kit may be metal members; for example, the support cylinder member 50 may be a copper member, which is not limited herein.

A side surface of the support cylinder member 50 is defined with a through hole 52 communicated with the mounting hole 51. The engagement member 44 is partially received in the through hole 52, and partially extends through the through hole 52 to be engaged in the engagement groove 621. The engagement member 44 may be a ball, namely a round bead made of metal. The reset member 45 may be a spring, such as a compression spring. There may be one, two, or more than two reset members 45.

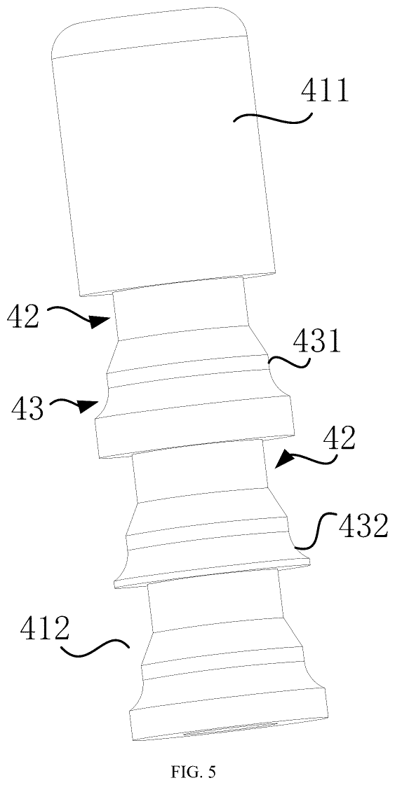

As shown in FIG. 5 and FIG. 6, in some embodiments, the engagement member 44 is located on a sliding path of the unlocking button 41. By pressing the unlocking button 41, the engagement member 44 can be released. When the unlocking button 41 is reset, the unlocking button 41 presses the engagement member 44 to allow the engagement member 44 to be engaged in the engagement groove 621. In other words, the unlocking button 41 is configured to press or release the engagement member 44. One end of the reset member 45 abuts against or is connected to the unlocking button 41, and the other end of the reset member 45 abuts against or is connected to a side wall of the mounting hole 51. The unlocking button 41 and the reset member 45 may be connected by a limiting column to improve the stability of the reset member 45.

In the embodiments, when the unlocking button 41 is pushed, the unlocking button 41 slides forward, and releases the engagement member 44 along with the sliding of the unlocking button 41, to allow the engagement member 44 to be disengaged from the engagement groove 621, thereby unlocking the tool member 60. In the unlocked state, the rotational connection part 61 of the tool member 60 can rotate around the support cylinder member 50. After releasing the unlocking button 41, the unlocking button 41 slides reversely under the action of the reset member 45, and presses the engagement member 44 along with the sliding of the unlocking button 41, to allow the engagement member 44 to be engaged in the engagement groove 621, thereby realizing locking. In the locked state, the rotational connection part 61 of the tool member 60 cannot rotate around the support cylinder member 50.

As shown in FIG. 4 and FIG. 5, in some embodiments, a pressing surface of the unlocking button 41 is defined with an avoidance groove 42, which is configured to avoid the engagement member 44 during the unlocking button 41 sliding so as to release the engagement member 44. This has the advantages of a simple structure and a convenient operation.

In the embodiments, the unlocking button 41 presses the engagement member 44 by way of the pressing surface of the unlocking button contacting the engagement member 44. Along with the process of pushing the unlocking button 41 to slide, the avoidance groove 42 leaves an initial position and reaches the position where the engagement member 44 is located to allow the engagement member 44 to enter the avoidance groove 42 from the pressing surface, such that the engagement member 44 is released, achieving the unlocking. After the unlocking button 41 is released, the unlocking button 41 is reset by the reset member 45 to slide, the avoidance groove 42 returns the initial position from the position where the engagement member 44 is located, and the engagement member 44 exits from the avoidance groove 42 and contacts the pressing surface again, such that the engagement member 44 is pressed, achieving the locking. In order to prevent the unlocking button 41 from sliding away from the mounting hole 51, the inner wall of the mounting hole 51 is convexly defined with a limiting part extending inward, and part of the unlocking button 41 abuts against the bottom surface of the limiting part. The part of the unlocking button 41 with a diameter smaller than that of the opening defined by the limiting part protrudes through the opening, which facilitates a user to push. The sliding distance of the unlocking button 41 does not need to be long. After unlocking, there may be a small distance between the upper wall of the avoidance r groove 42 and the upper surface of the engagement member 44.

As shown in FIG. 2 and FIG. 4, in some embodiments, the unlocking button 41 includes a pushing part 411 and a pressing part 412 connected with the pushing part 411. The pushing part 411 is at least partially exposed outside the support cylinder member 50, a pressing surface of the pressing part 412 is defined with the avoidance groove 42 and a limiting groove 43 communicated with avoidance groove 42. The engagement member 44 can slide into the avoidance groove 42 along the wall of the limiting groove 43. The wall of the limiting groove 43 is configured for the pressing part 412 to press the engagement member 44. The connection area between the wall of the limiting groove 43 and the wall of the avoidance groove 42 defines a pressing area 431, and the pressing area 431 is vertically disposed. The limiting groove 43 defines a limiting area 432 connected to the pressing area 431, and the limiting area 432 is configured to prevent the pressing part 412 from sliding away from the mounting hole 51.

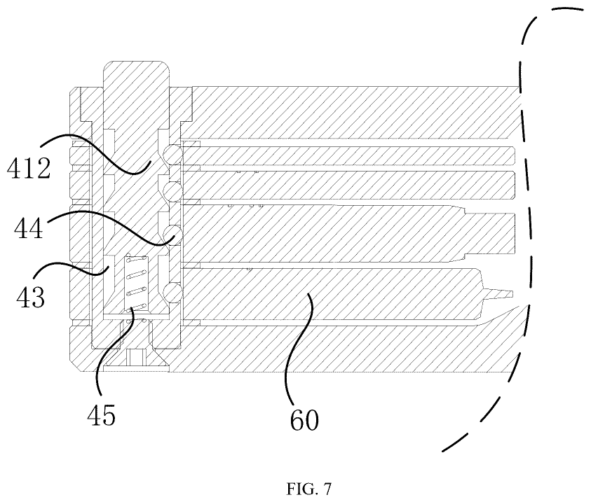

In the embodiments, in the locked state, the horizontal direction of the engagement member 44 is tangent to the vertical plane of the pressing area 431, and the bottom surface of the engagement member 44 abuts against the limiting area 432 below the pressing area 431 to prevent the reset member 45 from pushing the unlocking button 41 to slide away from the mounting hole 51. The limiting area 432 is a curved surface or an arc surface instead of a limiting inclined surface. In case the limiting area 432 is a limiting inclined surface, when the tool member 60 in the locked state rotates relative to the support cylinder member 50, the limiting inclined surface may apply an upward force on the engagement member 44, and the engagement member 44 will apply a downward reaction force back on the limiting inclined surface, such that the pressing part 412 will compress the reset member 45 to move downward, to allow the tool member 60 to be rotatable, resulting in a lock failure, as shown in FIG. 7.

As shown in FIG. 5, in some embodiments, in order to facilitate the engagement member 44 to slide into the avoidance groove 42, the wall of the avoidance groove 42 and the wall of the limiting groove 43 are connected by a guidance inclined surface (not labelled in the figure). The guidance inclined surface may be formed by the wall of the avoidance groove 42 and gradually incline upward.

In some embodiments, the vertical section of the bottom wall of the avoidance groove 42 connected with the guidance inclined surface may be a flat surface, or a curved surface.

As shown in FIG. 1, in some embodiments, one tool member 60 is fitted with one avoidance groove 42, and the number of the avoidance grooves 42 is set according to the number of the tool members 60. The pressing surface of the pressing part 412 is defined with a plurality of avoidance grooves 42 which are spaced apart. The number of the avoidance grooves 42, the number of the limiting grooves 43, the number of the engagement members 44, and the number of the tool members 60 are matched with one another; for example, the number is 4, 5, and the like.

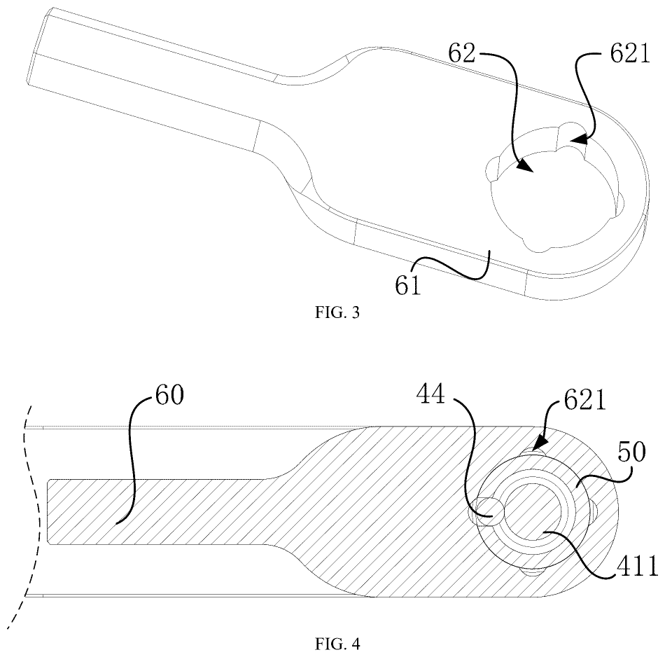

As shown in FIG. 3 and FIG. 4, in some embodiments, in order to lock the tool member 60 which has been rotated out of the accommodation space 30 to prevent the tool member 60 from rotating relative to the support cylinder member 50 during use, the inner wall of the sleeve hole 62 is concavely defined with at least two grooves 621 arranged at intervals. When the tool member 60 is accommodated in the accommodation space 30 and in the locked state, the engagement member 44 is engaged in one of the engagement grooves 621. When the tool member 60 has been rotated out of the accommodation space 30 and in the locked state, the engagement member 44 is engaged in another engagement groove 621. For example, there are four engagement grooves 621, which may be arranged at equal intervals or at unequal intervals. At least one damping gasket 70 is disposed on the support cylinder member 50, and adjacent tool members 60 are connected by the damping gasket 70.

In some embodiments, the free end of the tool member 60 is provided with any one of a cross wrench, an adjustable wrench, a hex wrench, a straight wrench, a bottle opener, a blade, and an adjustable hex wrench.

As shown in FIG. 1, in some embodiments, there are two tool assemblies, one of which is located between the first holding member 10 and the second holding member 20 and on a left side, and the other one of which is located between the first holding member 10 and the second holding member 20 and on a right side.

In some embodiments, one tool assembly includes three tool members 60. The damping gasket 70 is abutted between adjacent rotational connection parts 61. The free ends of the three tool members 60 are respectively provided with a first hex wrench, a second hex wrench, and a third hex wrench. The first hex wrench, the second hex wrench, and the third hex wrench have different sizes and specifications.

In some embodiments, the other tool assembly includes four tool members 60. The damping gasket 70 is abutted between adjacent rotational connection parts 61. The free ends of the four tool members 60 are respectively provided with a fourth hex wrench, a straight wrench, an adjustable hex wrench, and a cross wrench. The cross wrench is a tapered-head cross wrench or a flat-head cross wrench.

To sum up, in the storage state, all the tool members 60 of the two tool assemblies are stored in the accommodation space 30. One support cylinder member 50 is located between the second holding member 20 and the first holding member 10 and on the left side, and the other support cylinder member 50 is located between the second holding member 20 and the first holding member 10 and on the right side. The free ends of the tool members 60 are disposed close to one another. The two unlocking buttons 41 are located in the mounting holes 51, and the pushing parts 411 are partially exposed outside the mounting holes 51. Each engagement member 44 is located in one limiting groove 43. Besides, one surface of each engagement member 44 is tangent to the vertical section of one pressing area 431, and the other surface of the engagement member 44 passes through the through hole 52 of the support cylinder member 50 to be engaged in one engagement groove 621.

A user may rotate any one of the first hex wrench, the second hex wrench, the third hex wrench, the fourth hex wrench, the straight wrench, the adjustable hex wrench, and the cross wrench out of the accommodation space 30 for use. In the process of rotating a certain wrench out of the accommodation space 30, such as the first hex wrench, the pushing part 411 is pushed to drive the unlocking button 41 to slide forward, so as to allow the avoidance groove 42 to leave the initial position and reach the position of the engagement member 44. The engagement member 44 slides into the avoidance groove 42 from the limiting groove 43 along the guidance inclined surface, so that the unlocking button 41 release the engagement member 44. As a result, the engagement member 44 is disengaged from the engagement groove 621, thereby unlocking the first hex wrench. In the unlocked state, the rotational connection part 61 of the first hex wrench can rotate around the support cylinder member 50. After the rotational connection part 61 of the first hex wrench is rotated to the preset position, the unlocking button 41 is released. The unlocking button 41 slides reversely under the action of the reset member 45, so that the avoidance groove 42 resets from the position of the engagement member 44 to the initial position, and the engagement member 44 exits from the avoidance groove 42 and retreats into the limiting groove 43. Then the engagement member 44 is pressed to be engaged in another engagement groove 621, thereby realizing locking. In the locked state, the rotational connection part 61 of the first hex wrench cannot rotate around the support cylinder member 50, which facilitates the user to use the first hex wrench.

When the first hex wrench needs to be stored, the pushing part 411 is pushed again, to allow the unlocking button 41 to slide forward so as to unlock the rotational connection part 61 of the first hex wrench. In the unlocked state, the first hex wrench is rotated in the direction opposite to that of the original rotation, which is not detailed herein.

The above are only some embodiments of the present disclosure, and neither the words nor the drawings can limit the protection scope of the present disclosure. Any equivalent structural transformation made by using the contents of the specification and the drawings of the present disclosure under the overall concept of the present disclosure, or directly/indirectly applied in other related technical fields are included in the protection scope of the present disclosure.

What is claimed is:

1. A tool kit, comprising:
a first holding member;
a second holding member disposed in parallel with the first holding member, a support cylinder member being connected between the first holding member and the second holding member to form an accommodation space;
a tool assembly, the tool assembly comprising at least one tool member, the tool member being rotatably accommodated in the accommodation space, one end of the tool member being provided with a rotational connection part, the rotational connection part being rotatably sleeved on the support cylinder member through a sleeve hole defined in the rotational connection part, and an inner wall of the sleeve hole being concavely defined with an engagement groove; and
an unlocking assembly movably mounted in a mounting hole of the support cylinder member, the unlocking assembly comprising an unlocking button, an engagement member, and a reset member, the engagement member being exposed on an outer surface of the support cylinder member and fitted with the engagement groove, the unlocking button being slidably disposed in the mounting hole and at least partially exposed outside the support cylinder member, and the reset member being configured to apply a force on the unlocking button to reset the unlocking button;
wherein, the unlocking assembly has a locked state and an unlocked state; in the unlocked state, the unlocking button releases the engagement member to allow the engagement member to be disengaged from the engagement groove; and in the locked state, the unlocking button resets to press the engagement member to allow the engagement member to be engaged in the engagement groove.

2. The tool kit according to claim 1, wherein the engagement member is located on a sliding path of the unlocking button, the unlocking button is configured to press or release the engagement member, one end of the reset member abuts against or is connected to the unlocking button, and the other end of the reset member abuts against or is connected to a side wall of the mounting hole.

3. The tool kit according to claim 2, wherein a pressing surface of the unlocking button is defined with an avoidance groove, and the avoidance groove is configured to avoid the engagement member in a sliding process of the unlocking button so as to release the engagement member.

4. The tool kit according to claim 3, wherein the unlocking button comprises:
a pushing part; and
a pressing part connected with the pushing part;
wherein, the pushing part is at least partially exposed outside the support cylinder member, a pressing surface of the pressing part is defined with the avoidance groove and a limiting groove communicated with the avoidance groove, the engagement member is capable of sliding into the avoidance groove along a wall of the limiting groove, the wall of the limiting groove is configured for the pressing part to press the engagement member, a connection area between the wall of the limiting groove and a wall of the avoidance groove defines a pressing area that presses the engagement member, the pressing area is vertically arranged, the limiting groove defines a limiting area connected to the pressing area, and the limiting area is configured to prevent the pressing part from sliding away from the mounting hole.

5. The tool kit according to claim 4, wherein the wall of the avoidance groove and the wall of the limiting groove are connected by a guidance inclined surface.

6. The tool kit according to claim 4, wherein the pressing surface of the pressing part is defined with a plurality of the avoidance grooves which are spaced apart; and
the number of the avoidance grooves, the number of the limiting grooves, the number of the engagement members, and the number of the tool members are matched with one another.

7. The tool kit according to claim 1, wherein an inner wall of the sleeve hole is recessed with at least two engagement grooves which are spaced apart; in case the tool member is accommodated in the accommodation space and in the locked state, the engagement member is engaged in one of the at least two engagement grooves; and in case the tool member is rotated out of the accommodation space and in the locked state, the engagement member is engaged in another one of the at least two engagement grooves.

8. The tool kit according to claim 2, wherein an inner wall of the sleeve hole is recessed with at least two engagement grooves which are spaced apart; in case the tool member is accommodated in the accommodation space and in the locked state, the engagement member is engaged in one of the at least two engagement grooves; and in case the tool member is rotated out of the accommodation space and in the locked state, the engagement member is engaged in another one of the at least two engagement grooves.

9. The tool kit according to claim 3, wherein an inner wall of the sleeve hole is recessed with at least two engagement grooves which are spaced apart; in case the tool member is accommodated in the accommodation space and in the locked state, the engagement member is engaged in one of the at least two engagement grooves; and in case the tool member is rotated out of the accommodation space and in the locked state, the engagement member is engaged in another one of the at least two engagement grooves.

10. The tool kit according to claim 4, wherein an inner wall of the sleeve hole is recessed with at least two engagement grooves which are spaced apart; in case the tool member is accommodated in the accommodation space and in the locked state, the engagement member is engaged in one of the at least two engagement grooves; and in case the tool member is rotated out of the accommodation space and in the locked state, the engagement member is engaged in another one of the at least two engagement grooves.

11. The tool kit according to claim 5, wherein an inner wall of the sleeve hole is recessed with at least two engagement grooves which are spaced apart; in case the tool member is accommodated in the accommodation space and in the locked state, the engagement member is engaged in one of the at least two engagement grooves; and in case the tool member is rotated out of the accommodation space and in the locked state, the engagement member is engaged in another one of the at least two engagement grooves.

12. The tool kit according to claim 1, wherein a free end of the tool member is provided with any one of a cross wrench, an adjustable hex wrench, an adjustable wrench, a hex wrench, a straight wrench, a bottle opener, and a blade; and/or
the engagement member is a ball; and/or
the support cylinder member is provided with at least one damping gasket.

13. The tool kit according to claim 1, wherein the tool assembly is one of two tool assemblies, one tool assembly is located between the first holding member and the second holding member and on a left side, and the other tool assembly is located between the first holding member and the second holding member and on a right side.

14. The tool kit according to claim 13, wherein one tool assembly comprises three tool members, a damping gasket is abutted between adjacent rotational connection parts, and free ends of the three tool members are respectively provided with a first hex wrench, a second hex wrench, and a third hex wrench; the first hex wrench, the second hex wrench, and the third hex wrench have different sizes and specifications; and
the other tool assembly comprises four tool members, a damping gasket is abutted between adjacent rotational connection parts, and free ends of the four tool members are respectively provided with a fourth hex wrench, a straight wrench, an adjustable hex wrench, and a cross wrench.
